(19) United States
(12) Patent Application Publication
(10) Pub. No.: US 2024/0119363 A1
(43) Pub. Date: Apr. 11, 2024

(54) SYSTEM AND PROCESS FOR DECONFOUNDED IMITATION LEARNING

(71) Applicant: QUALCOMM Incorporated, San Diego, CA (US)

(72) Inventors: Risto VUORIO, London (GB); Pim DE HAAN, Amsterdam (NL); Johann Hinrich BREHMER, Amsterdam (NL); Hanno ACKERMANN, Amsterdam (NL); Taco Sebastiaan COHEN, Amsterdam (NL); Daniel Hendricus Franciscus DIJKMAN, Haarlem (NL)

(21) Appl. No.: 18/459,258

(22) Filed: Aug. 31, 2023

Related U.S. Application Data
(60) Provisional application No. 63/411,016, filed on Sep. 28, 2022.

(51) Int. Cl. G06N 20/00; G06N 5/04

(52) U.S. Cl. CPC G06N 20/00; G06N 5/04

(57) ABSTRACT

A processor-implemented method includes observing an environment via one or more sensors associated with a robotic device. The processor-implemented method also includes generating, via an inference model, a belief of the environment based on data associated with prior actions of the robotic device in the environment. The processor-implemented method further includes controlling the robotic device to perform an action in the environment based on generating the belief.

### CROSS-REFERENCE TO RELATED APPLICATION

The present application claims the benefit of U.S. Provisional Patent Application No. 63/411,016, filed on Sep. 28, 2022, and titled “SYSTEM AND PROCESS FOR DECONFOUNDED IMITATION LEARNING,” the disclosure of which is expressly incorporated by reference in its entirety.

### FIELD OF THE DISCLOSURE

Aspects of the present disclosure generally relate to deconfounded imitation learning.

### BACKGROUND

Artificial neural networks may include interconnected groups of artificial neurons (e.g., neuron models). The artificial neural network may be a computational device or be represented as a method to be performed by a computational device. Artificial neural networks may be used for a variety of tasks, such as image recognition, speech recognition, acoustic scene classification, keyword spotting, autonomous driving, and imitation learning.

In some examples, a machine learning model may learn to perform a task by observing an expert, such as a human, perform the task. The trained machine learning model may be associated with a device, such as (but not limited to) a robotic device, such that the trained machine learning model may control the device to perform the task. In such examples, the expert that performed the task may have more information about the task and/or the environment than the machine learning model. Therefore, the device may fail to perform the task if the machine learning model naively imitates the expert without having the same information as the expert.

### SUMMARY

The present disclosure is set forth in the independent claims, respectively. Some aspects of the disclosure are described in the dependent claims.

In some aspects of the present disclosure, a processor-implemented method includes observing an environment via one or more sensors associated with a robotic device. The method also includes generating, via an inference model, a belief of the environment based on data associated with prior actions of the robotic device in the environment. The method further includes controlling the robotic device to perform an action in the environment based on generating the belief.

Some other aspects of the present disclosure are directed to an apparatus including means for observing an environment via one or more sensors associated with a robotic device. The apparatus also includes means for generating, via an inference model, a belief of the environment based on data associated with prior actions of the robotic device in the environment. The apparatus further includes means for controlling the robotic device to perform an action in the environment based on generating the belief.

In some other aspects of the present disclosure, a non-transitory computer-readable medium with non-transitory program code recorded thereon is disclosed. The program code is executed by one or more processors and includes program code to observe an environment via one or more sensors associated with a robotic device. The program code also includes program code to generate, via an inference model, a belief of the environment based on data associated with prior actions of the robotic device in the environment. The program code further includes program code to control the robotic device to perform an action in the environment based on generating the belief.

Some other aspects of the present disclosure are directed to an apparatus having one or more processors, and one or more memories coupled with the one or more processors and storing instructions operable, when executed by the one or more processors, to cause the apparatus to observe an environment via one or more sensors associated with a robotic device. Execution of the instructions also cause the apparatus to generate, via an inference model, a belief of the environment based on data associated with prior actions of the robotic device in the environment. Execution of the instructions further cause the apparatus to control the robotic device to perform an action in the environment based on generating the belief.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 3 is a state diagram illustrating an example of a probabilistic model for a Bayesian network that generates data for a confounded expert.

FIG. 4 is a flow diagram illustrating an example of a process for training an inference model, in accordance with various aspects of the present disclosure.

FIG. 5 is a block diagram illustrating an example of an architecture for a latent variable model including an encoder and a decoder, in accordance with various aspects of the present disclosure.

FIG. 6 is a diagram illustrating an example of a function for learning an inference model and a deconfounded imitator policy, in accordance with various aspects of the present disclosure.

FIG. 7 is a flow diagram illustrating an example of a process for using a dynamics model to perform an action based on hidden information of an environment, in accordance with various aspects of the present disclosure.

### DETAILED DESCRIPTION

The detailed description set forth below in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As discussed, in some examples, a machine learning model associated with an imitator may learn to perform a task by observing an expert, such as a human, perform the task. For example, the machine learning model may be trained to perform a task, such as box lifting, by imitating demonstrations of the task performed by an expert. The imitator may also be referred to as an agent (hereinafter used interchangeably). In some examples, the imitator may be a robotic device or another type of autonomous or semi-autonomous device. Learning to perform a task by observing demonstrations may be referred to as imitation learning.

Imitation learning may be used in various applications, such as (but not limited to) autonomous driving and robotics. In most cases, imitation learning uses various functions such as behavioral cloning, inverse reinforcement learning, and adversarial methods. One challenge of imitation learning is the distribution mismatch between the expert and imitator due to errors accumulating when implementing the imitator's policy. This issue, which arises from the limited scope of expert actions, is distinct from the problem of latent confounders.

Several solutions have explored the crossover between causality and imitation learning. Some conventional solutions have focused on scenarios where the state is fully observable but the decisions of the expert stem from both causal and non-causal factors. Other conventional solutions have focused on the complexities arising from partial models that only utilize a segment of the state. Some other conventional solutions explore imitation learning in the context of latent variables influencing an expert policy.

The concept of meta-reinforcement learning (meta-RL) involves training an adaptable imitator to rapidly learn new tasks. Some meta-RL functions integrate a task encoder and a task-conditional policy. However, in contrast to the various aspects of the present disclosure, the tasks associated with meta-RL functions can have varying reward functions. In the context of multiple environments differing through latent factors, certain solutions suggest imitators adapt by probing their surroundings to discern these latent elements. However, these imitators typically operate in a reinforcement learning context with defined rewards, as opposed to the imitation learning method based on expert demonstrations.

As discussed, a particular challenge in imitation learning is when the expert that performed the task has more information about the task and/or the environment than the imitator. For example, when training the imitator to stack boxes on shelves, the imitator may not know whether a box is light or heavy because all of the boxes may look the same. That is, an appearance of a box may not be indicative of a weight of the box. However, the expert may know a weight of a box, or may estimate the weight of the box, by lifting the box. In some examples, the expert may lift one heavy box at a time with two arms or two light boxes at a time (e.g., one light box per arm). In such examples, the imitator cannot determine the weight of each box by simply viewing the boxes. By naively imitating the expert, the imitator may try to lift two heavy boxes at the same time, thereby failing to place the heavy boxes on a shelf. It may be desirable to improve imitation learning systems to account for situations in which the expert demonstrating a task has more information about the task and/or an environment than the imitator.

Various aspects of the present disclosure are directed to a systematic strategy of trial and error that identifies information about the task and/or the environment. For example, the imitator may use trial and error to identify the weights of boxes and behave like the expert once the true weights are identified. Particular aspects of the subject matter described in this disclosure can be implemented to realize one or more of the following potential advantages. In some examples, by using the systematic trial and error solution, the imitator can discern attributes (e.g., characteristics) of an environment, such as the weights of boxes. Once these attributes are determined, the imitator can then emulate the expert's behavior. The key benefit of this solution lies in its proactive and adaptive nature, allowing the imitator to autonomously gather essential data and subsequently align its actions with the expert, ensuring more accurate task execution.

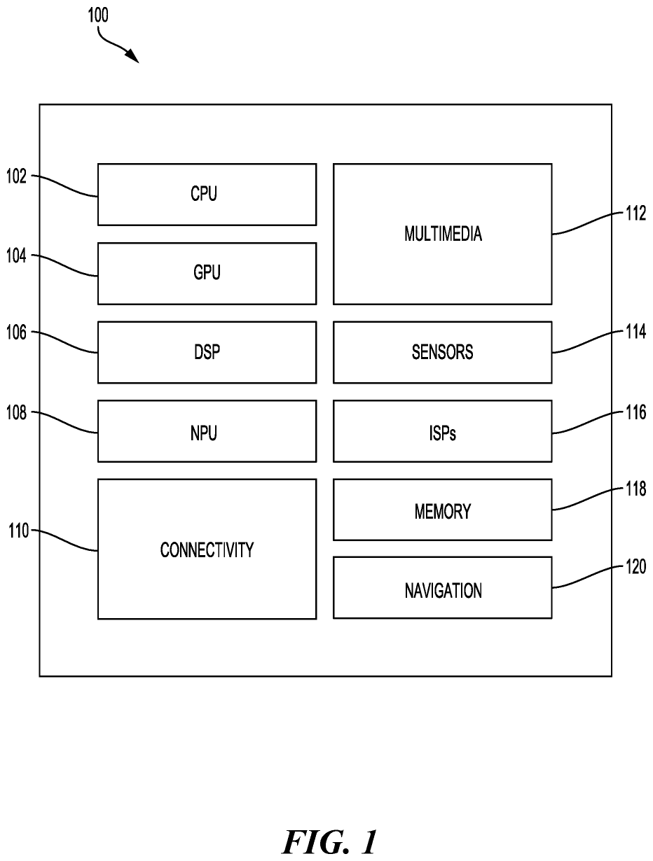

FIG. 1 illustrates an example implementation of a system-on-a-chip (SOC) 100, which may include a central processing unit (CPU) 102 or a multi-core CPU configured for deconfounded imitation learning. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to observe an environment; generate, via an inference model, a belief of the environment based on data associated with prior actions of an expert in the environment; and control a device to perform an action in the environment based on generating the belief.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

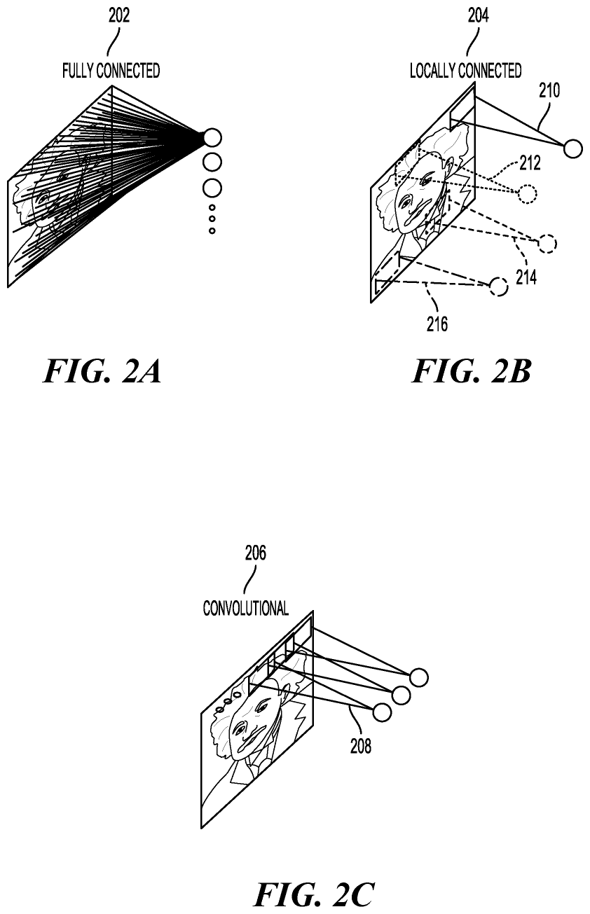

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

In some cases, if the expert has more information about the world than the imitator, and if the expert uses the additional information to select one or more actions, it may be difficult for the imitator to directly imitate the expert. In imitation learning, this problem may be referred to as causal confounding. This type of confounding may be due to one or more factors, such as different sensors between the expert and the imitator, or different robot configurations. In some examples, the expert's extra knowledge of the world may be modeled as a hidden variable in a neural network, such as a Bayesian network, describing the expert's interaction with the world.

As discussed, imitation learning may be used to train a controller, such as a controller of a robotic device, to perform a task. Specifically, imitation learning is used by an imitator to learn a policy from a dataset of expert demonstrations via supervised learning. That is, a machine learning model may be trained to predict an action of an expert as a supervised learning problem. The expert may be a human or another robotic device. The expert refers to the human or device that performs a task; the expert may not have a particular expertise in the task. In some examples, the expert may be associated with a policy that acts in a (reward-free) Markov decision process (MDP) defined by a tuple [symbol] =( [symbol] , [symbol] , P(s′|s, a), P(s₀)), where [symbol] is the set of states, [symbol] is the set of actions, P(s′|s, a) is the transition probability, and P(s₀) is a distribution over initial states. The expert's interaction with the environment produces a trajectory τ=(s₀, a₀, . . . , a_{T-1}, s_{T}). The expert may maximize the expectation over some reward function. Still, some tasks cannot be expressed through Markov rewards. In some imitation learning examples, a behavioral cloning policy π_{η}(a|s) parametrized by η is learned by minimizing the loss— [symbol] log π_{η}(a|s), where a parameter [symbol] represents the dataset of state-action pairs collected by the expert's policy.

In some examples, imitation learning may be expanded to allow for some variables θ∈Θ that are observed by the expert, but not the imitator. A family of Markov decision processes may be defined by a latent space Θ, a distribution P(θ), and for each θ∈Θ, a reward-free MDP [symbol] _{θ}=( [symbol] , [symbol] , P(s′|s, a, θ), P(s₀|θ)). It may be assumed that expert policy πₑₓₚ(a|s, θ) exists for each MDP. The expert policy πₑₓₚ(a|s, θ) represents a probability of the expert taking an action a when in state s, given the latent variable θ. Specifically, the expert policy describes how the expert behaves in various states, considering the latent variable θ. When the expert policy πₑₓₚ(a|s, θ) interacts with the environment, the interaction may generate the following distribution over trajectories τ:

Pₑₓₚ(τ|θ)=P(s₀|θ)Πₜ₌₀^{T}P(sₜ₊₁|sₜ,aₜ;θ)πₑₓₚ(aₜ|sₜ;θ). (1)

In Equation 1, P(sₜ₊₁|sₜ, aₜ; θ) represents, for each time step t, the probability distribution of transitioning to the next state sₜ₊₁ given the current state sₜ, the action taken aₜ, and the latent variable θ. That is, the dynamics of the environment may indicate a likelihood of ending up in a particular state sₜ₊₁ after taking an action aₜ in our current state sₜ, under the influence of the latent variable θ. During imitation learning, the imitator does not observe the latent θ. Therefore, the imitator may implicitly infer the latent θ from the past transitions. Thus, in some conventional systems, the imitator may be associated with a non-Markovian policy π_{η}(aₜ|s₁, a₁, . . . , sₜ), parameterized by a parameter η. That is, in a Markovian system, the future state may depend on the current state and not on the sequence of states that preceded it. However, in a non-Markovian system, the future depends on past events. Thus, the non-Markovian policy π_{η}(aₜ|s₁, a₁, . . . , sₜ) takes into account the entire history of states and actions up to time t to decide on an action aₜ at time t. In some examples, the imitator generates the following distribution over trajectories τ:

P_{η}(τ|θ)=P(s₀|θ)Πₜ₌₀^{T}P(sₜ₊₁|sₜ,aₜ;θ)π_{η}(aₜ|s₀,a₀, . . . ,sₜ). (2)

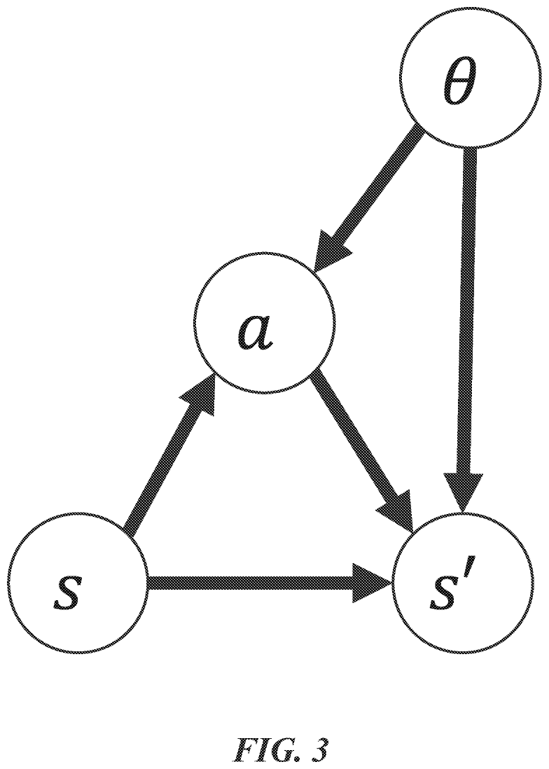

FIG. 3 is a state diagram illustrating an example of a probabilistic model for a Bayesian network that generates data for a confounded expert. In the example of FIG. 3, s represents an initial state of an environment, a represents an action of an expert, and s′ represents a state of the environment after the expert has taken the action a. Additionally, a latent variable θ represents hidden information, available to the expert, about the environment. The latent variable θ affects both the action a and the state of the environment s′ after the expert has taken the action a. Conventional imitation learning systems do not disambiguate the effect of the latent variable θ on both the action a and the state of the environment s′ after the expert has taken the action a.

In the realm of imitation learning, when the latent variable θ is used for a policy, it may be desirable to fine-tune the parameters η of the imitator, such that during interactions with the environment, the imitator's decisions closely mirror those of the expert. The mathematical objective of this alignment is represented by maximizing the expectation over the latent variable distribution [symbol] _{θ˜P(θ)} and then, within that, over the trajectories that the imitator's policy produces [symbol] _{τ˜P}_{_{η}}_{(τ;θ)} (e.g., [symbol] _{θ˜P(θ)} [symbol] _{τ˜P}_{_{η}}_{(τ;θ)}[Σₛ_{ₜ}_{,a}_{ₜ}_{∈τ}log πₑₓₚ(aₜ|sₜ, θ)]). Accordingly, for every trajectory, the goal is to sum the logarithms of the expert's policy values for all state-action pairs. In essence, this summation evaluates how likely it is for the expert's policy to replicate the decisions found in the imitator's trajectory. If the expert is optimally performing a task (e.g., maximizing a certain reward function), then aligning the imitator's actions with the expert's action inherently means that the imitator is also equipped to solve that same task optimally. This approach underscores the central idea of imitation learning in such settings: to cultivate an imitator that, when active within an environment, replicates the expert's behavior and thereby achieves analogous results.

Conventional imitation learning systems do not disambiguate the effect the hidden variable has on the expert's choice of action and the effect it has on the dynamics of the environment. Therefore, when a machine learning model trained with naive imitation learning is deployed in the real world, the machine learning model may incorrectly interpret previous actions of an associated device as evidence of the hidden variable, and therefore, choose the wrong actions going forward based on this faulty inference.

Various aspects of the present disclosure are directed to improving imitation learning systems by overcoming the aforementioned limitations of conventional imitation learning systems. Specifically, in some examples, an inference model of an imitator may be trained using the hidden information that is used by an expert to make a decision. During training, the inference model may be used to explain the expert's behavior, and thereby enable imitation learning. When the imitator is deployed, the inference model incrementally gains more information about the environment and improves an accuracy of an imitation. In some examples, the inference model may be a variational encoder-decoder that predicts the effects of the actions in the environment. The training data for the model is gathered using a random policy. The model generates a latent variable representing a belief of the environment, which is intended to represent the information used by the expert to make decisions. The concept of using a learned predictive model for deconfounding the expert data is novel.

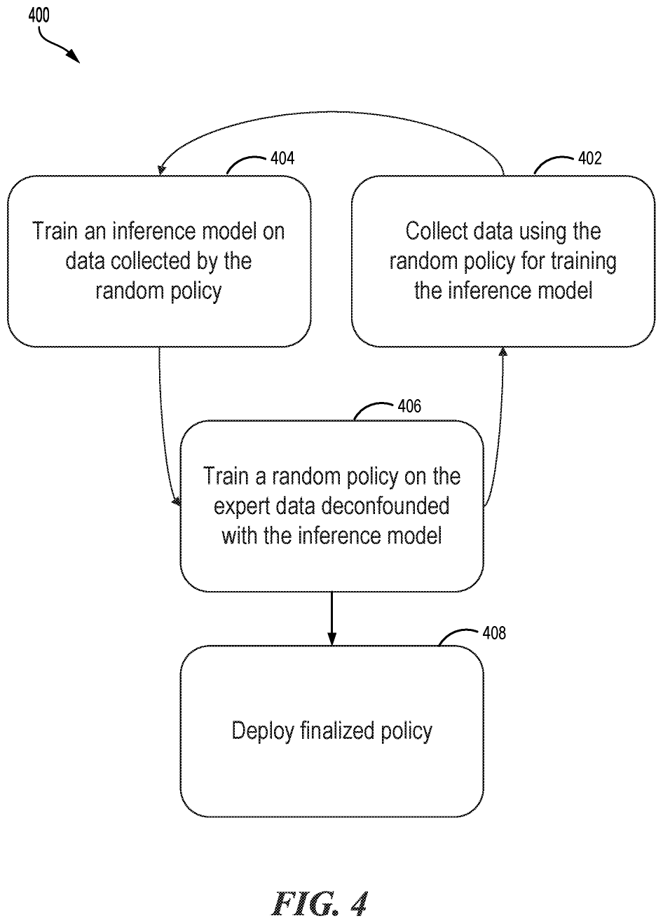

FIG. 4 is a flow diagram illustrating an example of a process 400 for training an inference model, in accordance with various aspects of the present disclosure. As shown in FIG. 4, at block 402, the process 400 collects data using a random policy for training an inference model. The data may be observations of an environment and/or observations of actions of an imitator. Additionally, at block 404, the process 400 trains an inference model on data collected by the random policy. The data may include actions of an expert and information of the environment. The data may be gathered from one or more sensors of the imitator. In some examples, an imitator may be a device, such as a robotic device, that implements one or more of a random policy, an imitation policy or an interference model. The inference model may also be referred to as a hidden variable prediction model. The inference model receives trajectories as inputs and predicts the latent variable. The imitation policy receives the state of the environment and the predicted latent variable as the input. A dynamics model may be used for training the inference model. The dynamics model receives one or more inputs, including the predicted latent variable, the state of the environment, and the action selected by a policy, and predicts the next state.

At block 406, the process 400 trains a random policy for the imitator to perform actions based on the expert data that is deconfounded with the inference model. In some examples, the process 400 may estimate the effect of hidden information on the expert and then account for the effect of the hidden information once the inference model has been trained. In some implementations, that is, after training the inference model, expert demonstrations may be tagged with the inferred latent variables. This enriched dataset, now free from confounding factors, serves as the basis for conventional behavioral cloning. At block 408, a finalized policy, generated through the process associated with blocks 402, 404, and 406, may be deployed in real-world tests, in conjunction with the inference model.

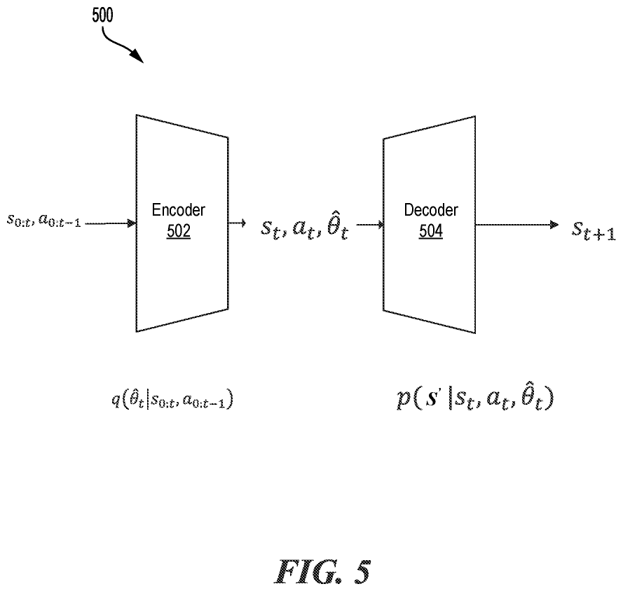

FIG. 5 is a block diagram illustrating an example of an architecture for a latent variable model 500 including an encoder 502 and a decoder 504. The latent variable model 500 may be executed by one or more processors, such as an SOC 100 described with reference to FIG. 1. In the example of FIG. 5, the encoder 502 may be an example of an inference model q_{ϕ} and the decoder 504 may be an example of a dynamics model p_{ψ}.

As shown in the example of FIG. 5, the encoder 502 may receive observations s of the environment from an initial time sₒ to a current time sₜ, where t represents a time step counter. The encoder 502 may also receive actions a of the imitator from an initial time aₒ to a current time aₜ. The observations s may be based on observations of the imitator. Specifically, the encoder 502 may receive trajectories τ=(s₀, a₀, . . . , sₜ) The observations sₜ may include, for example, positions and poses of all the objects in the environment, and/or velocities of the different objects. The actions a may include, for example, a position of a device (e.g., a robotic arm) associated with the imitator, or a position (e.g., pose) of the imitator.

The encoder 502 may implement a function q_{ϕ}(\hat{θ}ₜ|s_{0:t}, a_{0:t}) for generating a probability distribution for estimated hidden information \hat{θ}ₜ of the environment at time t, given the actions a_{0:t} and the observations s_{0:t}. The encoder 502 selects one possible belief of the environment, which is represented as the estimated hidden variable \hat{θ}ₜ, for example \hat{θ}ₜ˜q_{ϕ}(\hat{θ}ₜ|s_{0:t}, a_{0:t}). In some examples, an action aₜ may be sampled from a policy π, for example aₜ˜π_{η}(aₜ|sₜ, \hat{θ}ₜ), which is a probability distribution of one or more actions aₜ that are conditional on a current state sₜ and a current belief (estimated hidden variable \hat{θ}ₜ). The imitator may perform the sampled action aₜ. The dynamics of the environment determine the next state sₜ₊₁ based on the current state sₜ, the selected action aₜ, and the actual hidden information θₜ.

In some examples, the decoder 504 may be used for training the encoder 502 and may generate an estimated probability distribution of a next state sₜ₊₁ given the current state sₜ, the selected action aₜ, and the estimated hidden information \hat{θ}ₜ. p(sₜ₊₁|sₜ, aₜ, θₜ) represents dynamics of the environment (e.g., real world dynamics). A next state sₜ₊₁ may also be represented as s′. The dynamics may be observed in the real world and stored as training data. The dynamics model p_{ψ}(s′|sₜ, aₜ, \hat{θ}ₜ) (shown as p(s′|sₜ, aₜ, \hat{θ}ₜ) in FIG. 5) may then be trained to predict the dynamics of the environment.

The encoder 502 and decoder 504 may be trained to minimize a loss [symbol] ᵢ:

[symbol]

ᵢ= [symbol] _{\hat{θ}˜q}_{_{ϕ}}_{(\hat{θ}|τ}_{_{:t}}_{ⁱ}₎[log p_{ψ}(sₜ₊₁|sₜ,aₜ,\hat{θ})]−βD_{KL}(q_{ϕ}(\hat{θ}|τ_{:t}ⁱ)∥q_{ϕ}(\hat{θ}|τ_{:t-1}ⁱ)). (3)

In Equation 3, D_{K L}(q_{Φ}(\hat{θ}|τ_{:t}ⁱ)∥q_{ϕ}(\hat{θ}|τ_{:t-1}ⁱ)) is based on a variational autoencoder (VAE) derivation that keeps a distribution of the belief of the hidden variable \hat{θ} similar to a prior. To minimize the loss in Equation 3, the encoder 502 encodes in the learned latent \hat{θ} all of the information in the ground-truth latent θ that is used to predict a state transition. In some examples, training data for the encoder 502 may be collected from the interactions of an exploration policy with the environment. The exploration policy may be a latent-conditional policy π_{η}, sampling \hat{θ} from the inferred distribution q_{ϕ}(\hat{θ}|τ_{:t}ⁱ). Other exploration policies may be used as long as they explore sufficiently diverse trajectories and do not depend on the true latent θ. The trained encoder 502 may be used for inferring latents in expert data distribution. These inferences are valid despite the distribution shift from exploratory data to expert data, as the transition model is the same. Subsequently, conventional imitation learning can be applied to develop a policy based on the latents identified from the expert's demonstrations. That is, after training the inference model, it becomes possible to tag expert demonstrations with the inferred latent variables. This enriched dataset, now free from confounding factors, serves as the basis for conventional behavioral cloning. The finalized policy, generated through this process, is then deployed in real-world tests, in conjunction with the inference model.

At test time, the imitator (e.g., agent) faces an environment with an unknown latent and needs to adapt to the correct expert behavior. In some examples, the imitator adapts to the correct expert behavior by alternating between updating a posterior belief over the latent and acting under the current belief. In such examples, the imitator initially samples a latent from the prior \hat{θ}˜ [symbol] (0, [symbol] ) and an action a˜π_{η}(a|s, \hat{θ}) to imitate the expert corresponding to that latent. The imitator then observes the state transition and computes the posterior belief with the inference network. Another latent is sampled from the updated belief, and the process repeats itself. Once the inference has converged to match the true latent for the environment, the true expert for the environment may be consistently imitated.

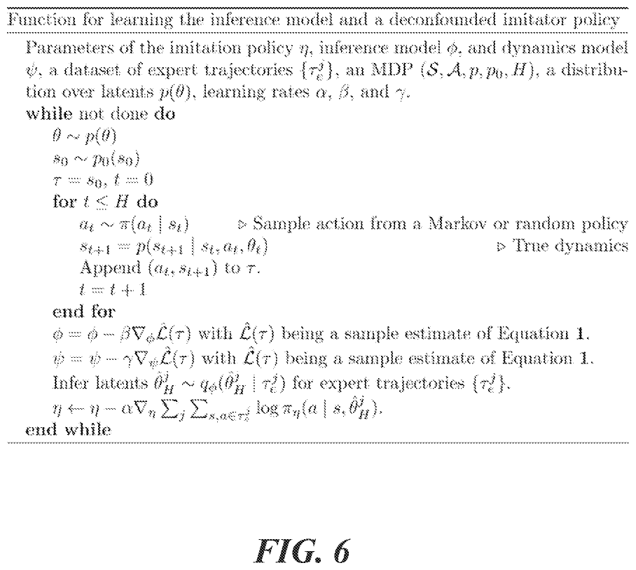

FIG. 6 is a diagram illustrating an example of a function for learning an inference model and a deconfounded imitator policy, in accordance with various aspects of the present disclosure. In the example of FIG. 6, the dataset of expert trajectories is represented by τₑ^{j}, where j represents an index to a dataset and e is an index that represents a particular expert. The dataset of expert trajectories τₑ^{j} may be obtained from the observations of one or more experts performing a task. The imitator may act in a Markov decision process (MDP), which may be defined as a tuple including states s, actions a, dynamics probabilities p, a probability of initial states p₀, and a horizon H that defines a number of steps that may be taken in the MDP.

The function for learning the inference model and a deconfounded imitator policy of FIG. 6 may be a loop that is initialized by sampling a latent variable θ from a distribution over latents p(θ), such that the latent variable θ represents hidden information about a current environment of the imitator. The latent variable θ may also be referred to as a hidden variable θ. In the example of moving boxes, the environment may be a warehouse or a simulated warehouse and the latent variable θ may represent a weight of the boxes in the environment. The deconfounded imitation learning function may then sample an initial state s₀ from the probability of initial states p₀. A trajectory τ may be initialized based on the initial state s₀, and a counter t may be initialized to zero. The variable t may also refer to steps in the loop. The loop may continue until the counter t is greater than the horizon H. The first step within the loop uses the trained inference model.

A learned imitator may be a combination of an inference model and an imitator policy. The learned imitator may be deployed in an environment. The inference model may be represented as a function q_{ϕ}(\hat{θ}ₜ|τ), which generates a probability distribution for estimated hidden information \hat{θ}ₜ of the environment given the trajectory τ after t steps. The inference model q_{ϕ} selects one possible belief of the world, which is represented as the estimated hidden variable \hat{θ}ₜ. For example, the inference model may select the belief that there are two heavy boxes in the environment. Next, an action aₜ may be sampled from a policy π_{η}, which is a probability distribution on some actions aₜ that are conditional on a current state sₜ and a current belief (estimated hidden variable \hat{θ}ₜ). The imitator may perform the sampled action aₜ. The next state sₜ₊₁ will be determined by the environment dynamics based on the current state sₜ, the selected action aₜ, and the actual hidden information θₜ. The next state sₜ₊₁ and the selected action aₜ may be appended to the trajectory τ and the counter t may then be updated (e.g., t+1). The loop may then repeat if the value of the counter t is less than or equal to a value of the horizon H.

In one example, a belief (estimated hidden variable \hat{θ}ₜ), based on the inference model q_{ϕ}, may be that there is one light box in the warehouse. The imitator may then pick up one box and determine the box is light. The belief in the state of the environment may then be updated. The current example may be an example of using the learned policy at test time. In some examples, training data for the inference model is collected using a random policy. Specifically, the inference model q_{φ} and the dynamics model ψ may be updated to minimize a loss [symbol] ᵢ, which is based, in part, on a log probability log p_{ψ}( ) of a next state sₜ₊₁, given the current state sₜ, the current action sₜ, and the current belief of the hidden variable \hat{θ}. The loss [symbol] ᵢ is defined in Equation 3.

As shown in FIG. 6, the respective losses of the inference model Φ and the dynamics model ψ may be optimized based on the trajectory τ. In some examples, the inference model Φ parameters and/or the dynamics model ψ parameters may be updated to minimize the respective losses. The trained dynamics model ψ may then be used to analyze the expert trajectories τₑ^{j}. Specifically, the trained dynamics model ψ may be used to infer the values of the hidden variable \hat{θ}_{H}^{j} for the expert trajectories τₑ^{j}. The inference learning function may then label the dataset of expert trajectories τₑ^{j} based on the inferred values of the hidden variable \hat{θ}_{H}^{j}. Next, the inference learning function may minimize a loss of the exploration policy η using the final belief \hat{θ}_{H}^{j}.

In some examples, a dynamics model may be trained, via imitation learning, from confounded data without access to the expert. Conventional systems query the expert during imitation learning. Querying the expert may use time and/or resources because of an amount of samples that may be needed by the machine learning model, such as the inference model and/or the dynamics model.

As discussed, training data for the inference model may be collected via online interactions with the environment. In some examples, the inference model may be trained offline. In such examples, when an amount of data in the expert dataset is greater than a threshold, the latent inference model can be trained from the expert data alone without an online interaction with the environment.

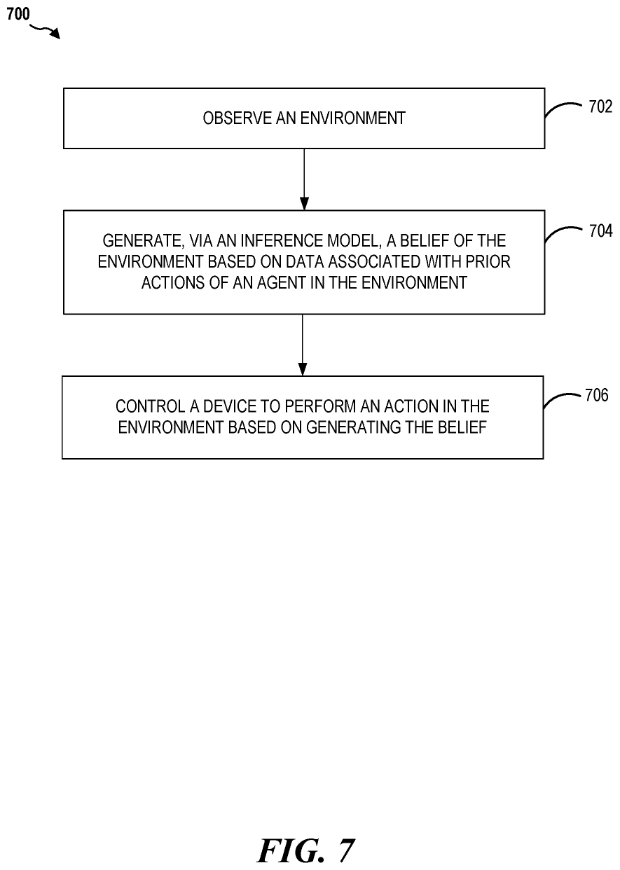

FIG. 7 is a flow diagram illustrating an example of a process 700 for using a dynamics model to perform an action based on hidden information of an environment, in accordance with various aspects of the present disclosure. The process 700 may be performed by an SOC 100 as described with respect to FIG. 1. As shown in FIG. 7, the process 700 begins at block 702 by observing an environment. At block 704, the process 700 generates, via an inference model, a belief of the environment based on data associated with prior actions of an expert in the environment. At block 706, the process 700 controls a device to perform an action in the environment based on generating the belief.

Implementation examples are described in the following numbered clauses:
Clause 1. A processor-implemented method comprising: observing an environment via one or more sensors associated with a robotic device; generating, via an inference model, a belief of the environment based on data associated with prior actions of the robotic device in the environment; and controlling the robotic device to perform an action in the environment based on generating the belief.
Clause 2. The processor-implemented method of Clause 1, further comprising training the inference model based on the data associated with prior actions of an expert in the environment.
Clause 3. The processor-implemented method of any one of Clauses 1-2, wherein a dynamics model trains the inference model.
Clause 4. The processor-implemented method of any one of Clauses 2-3, wherein the data associated with the prior actions is deconfounded from the inference model.
Clause 5. The processor-implemented method of any one of Clauses 1-4, wherein the inference model is a component of a variational encoder-decoder.
Clause 6. The processor-implemented method of Clauses 1-5, wherein training the inference model includes minimizing a first loss for the dynamic model and minimizing a second loss the inference model.
Clause 7. The processor-implemented method of any one of Clauses 2-6, further comprising observing the prior actions of the agent in the environment via one or more sensors of the device.
Clause 8. The processor-implemented method of any one of Clauses 2-7, wherein the expert is a human or another robotic device.
Clause 9. An apparatus comprising one or more processors, one or more memories coupled with the one or more processors, and instructions stored in the one or more memories and operable, when executed by the one or more processors to cause the apparatus to perform any one of Clauses 1 through 8.
Clause 10. An apparatus comprising at least one means for performing any one of Clauses 1 through 8.
Clause 11. A computer program comprising code for causing an apparatus to perform any one of Clauses 1 through 8.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method comprising:
observing an environment via one or more sensors associated with a robotic device;
generating, via an inference model, a belief of the environment based on data associated with prior actions of the robotic device in the environment; and
controlling the robotic device to perform an action in the environment based on generating the belief.

2. The processor-implemented method of claim 1, further comprising training the inference model based on the data associated with prior actions of an expert in the environment.

3. The processor-implemented method of claim 2, wherein a dynamics model trains the inference model.

4. The processor-implemented method of claim 3, wherein the data associated with the prior actions is deconfounded from the inference model.

5. The processor-implemented method of claim 3, wherein the inference model is a component of a variational encoder-decoder.

6. The processor-implemented method of claim 2, wherein training the inference model includes minimizing a first loss for the dynamic model and minimizing a second loss the inference model.

7. The processor-implemented method of claim 2, further comprising observing the prior actions of the agent in the environment via one or more sensors of the device.

8. The processor-implemented method of claim 2, wherein the expert is a human or another robotic device.

9. An apparatus comprising:
means for observing an environment via one or more sensors associated with a robotic device;
means for generating, via an inference model, a belief of the environment based on data associated with prior actions of the robotic device in the environment; and
means for controlling the robotic device to perform an action in the environment based on generating the belief.

10. The apparatus of claim 9, further comprising means for training the inference model based on the data associated with prior actions of an agent in the environment.

11. The apparatus of claim 10, wherein a dynamics model trains the inference model.

12. The apparatus of claim 11, wherein the data associated with the prior actions is deconfounded from the inference model.

13. The apparatus of claim 11, wherein the inference model is a component of a variational encoder-decoder.

14. The apparatus of claim 10, wherein the means for training the inference model comprises means for minimizing a first loss for the dynamic model and minimizing a second loss the inference model.

15. The apparatus of claim 10, further comprising means for observing the prior actions of the agent in the environment via one or more sensors of the device.

16. The apparatus of claim 10, wherein the expert is a human or another robotic device.

17. An apparatus comprising:
one or more processors; and
one or more memories coupled with the one or more processors and storing instructions operable, when executed by the one or more processors, to cause the apparatus to:
observe an environment via one or more sensors associated with a robotic device;
generate, via an inference model, a belief of the environment based on data associated with prior actions of the robotic device in the environment; and
control the robotic device to perform an action in the environment based on generating the belief.

18. The apparatus of claim 17, wherein execution of the instructions further cause the apparatus to train the inference model based on the data associated with prior actions of an agent in the environment.

19. The apparatus of claim 18, wherein a dynamics model trains the inference model.

20. The apparatus of claim 19, wherein the data associated with the prior actions is deconfounded from the inference model.

21. The apparatus of claim 19, wherein the inference model is a component of a variational encoder-decoder.

22. The apparatus of claim 18, wherein execution of the instructions that cause the apparatus to train the inference model further cause the apparatus to minimize a first loss for the dynamic model and minimizing a second loss the inference model.

23. The apparatus of claim 18, wherein execution of the instructions further cause the apparatus to observe the prior actions of the agent in the environment via one or more sensors of the device.

24. The apparatus of claim 18, wherein the expert is a human or another robotic device.

25. A non-transitory computer-readable medium having program code recorded thereon, the program code executed by one or more processors and comprising:
program code to observe an environment via one or more sensors associated with a robotic device;
program code generate, via an inference model, a belief of the environment based on data associated with prior actions of the robotic device in the environment; and
program code control the robotic device to perform an action in the environment based on generating the belief.

26. The non-transitory computer-readable medium of claim 25, wherein the program code further comprises program code to train the inference model based on the data associated with prior actions of an agent in the environment.

27. The non-transitory computer-readable medium of claim 26, wherein a dynamics model trains the inference model.

28. The non-transitory computer-readable medium of claim 27, wherein the data associated with the prior actions is deconfounded from the inference model.

29. The non-transitory computer-readable medium of claim 27, wherein the inference model is a component of a variational encoder-decoder.

30. The non-transitory computer-readable medium of claim 26, wherein the program code to train the inference model further comprises program code to minimize a first loss for the dynamic model and minimizing a second loss the inference model.
